(19) United States
(12) Patent Application Publication
(10) Pub. No.: US 2025/0371486 A1
(43) Pub. Date: Dec. 4, 2025

(54) System and Method for Peer-to-Peer Package Delivery

(71) Applicants: Mansoor Sarwar, Ashburn, VA (US); Tahir Awan, Falls Church, VA (US)

(72) Inventors: Mansoor Sarwar, Ashburn, VA (US); Tahir Awan, Falls Church, VA (US)

(21) Appl. No.: 19/220,555

(22) Filed: May 28, 2025

Related U.S. Application Data
(60) Provisional application No. 63/652,718, filed on May 29, 2024.

(51) Int. Cl. G06Q 10/0834; G06Q 10/0833; G06Q 20/02; G06Q 50/00

(52) U.S. Cl. CPC G06Q 10/0834; G06Q 10/0833; G06Q 20/027; G06Q 50/01

(57) ABSTRACT

A crowd-sourced package delivery system is disclosed. The system comprises a mobile application and browser-accessible interface linked to a backend server comprising modules for user management, package information, matching and recommendation, payment processing, fraud detection, and flight tracking. A machine learning-based pricing engine computes delivery prices using structured inputs including route distance, item weight, item category, and flight date. A multi-phase non-linear weight pricing function and price ceiling constraint ensure cost-effectiveness. The pricing model employs a hybrid neural network architecture incorporating embedding layers, graph attention networks, and quantile regression output with contextual attention mechanisms. A composite loss function balances quantile accuracy, market competitiveness, and elasticity modeling.

### CROSS-REFERENCE TO RELATED APPLICATION

The present application claims priority to, and the benefit of, U.S. Provisional Application No. 63/652,718 which was filed on May 29, 2024 and is incorporated herein by reference in its entirety.

### FIELD OF THE INVENTION

The present invention generally relates to the field of logistics and delivery systems. More specifically, the present invention relates to a crowd-sourced package delivery platform configured to enable secure, efficient, and cost-effective transport of goods by leveraging unused luggage space/carrying capacity of passengers or travelers (i.e., airline passengers). The system features a modular client-server architecture incorporating real-time matching algorithms, identity verification mechanisms, dynamic pricing intelligence, and live flight tracking. The platform is accessible via a mobile application and web interface, and is designed to accommodate various delivery requirements, travel schedules, and package types. The invention integrates advanced neural network models for personalized price prediction and employs a privacy-preserving federated learning architecture to ensure data confidentiality and scalable training. Accordingly, the present disclosure makes specific reference thereto. Nonetheless, it is to be appreciated that aspects of the present invention are also equally applicable to other like applications, devices, and methods of manufacture.

### BACKGROUND

By way of background, international shipping traditionally involves high costs, rigid logistics frameworks, and long transit times, often making it unsuitable for individuals or small businesses requiring fast, affordable delivery services. Particularly in cases involving short-notice or urgent delivery deadlines, conventional shipping providers face challenges to accommodate such demands efficiently due to limitations in scheduling flexibility, operational overhead, and fixed-route networks.

Moreover, the reliance on centralized infrastructure and the requirement for physical warehousing contribute to increased shipping fees and extended delivery durations. Such limitations create logistical inefficiencies and economic barriers for senders, especially when transporting small or medium-sized items across borders or to remote destinations. Individuals desire a decentralized and peer-driven approach to transport packages conveniently and economically.

Therefore, there exists a long-felt need in the art for a peer-to-peer international package delivery system that overcomes the cost, delay, and inflexibility inherent in conventional shipping services. There is a long-felt need for a system that enables individuals to send packages internationally or domestically with greater speed, affordability, and transparency. Additionally, there is a long-felt need for a delivery model that offers real-time tracking, dynamic pricing, and secure communication between the sender and the courier. There is also a long-felt need for a system that harnesses underutilized travel carrying capacity, particularly airline luggage space/carrying capacity. Furthermore, there is a long-felt need for a delivery solution that incorporates AI-driven matching, robust identity verification, and intelligent pricing algorithms to ensure fairness, efficiency, and trust throughout the logistics process. Finally, there is a long-felt need in the art for a package delivery system that enables passengers to receive discounts or monetary incentives for transporting packages and offers a fast-shipping solution for international packages.

The subject matter disclosed and claimed herein, in one embodiment, comprises a crowd-sourced package delivery system referred to as ‘skyporter’. The system includes a client-server architecture accessible via a mobile application and web interface, and connects senders with passengers or travelers (i.e., airline passengers) (referred to as porters) who have surplus luggage capacity and/or carrying capacity. The system backend comprises multiple modules, including a user management module to handle registration and verification, a package information module to collect package and travel details, and a matching and recommendation module to algorithmically pair senders with suitable porters. Additionally, the platform integrates a payment module that supports multi-currency transactions and escrow handling, and a communication module that enables secure, real-time messaging and media sharing between users.

In another embodiment, the system includes an advanced fraud detection module that applies AI-based document verification and facial recognition to validate user identity, ensuring secure onboarding and reducing the risk of impersonation or fraud. A flight and package tracking module integrates with third-party flight tracking services to offer real-time status updates on the passenger's flight, automatically syncing package visibility for the sender. The system also features a customer support module, offering ticket-based help, live chat, and a self-service FAQ center to ensure responsive issue resolution during any phase of the transaction. The pricing functionality is enhanced through an intelligent, machine learning-based pricing recommendation. The system accepts structured input features such as item weight, flight distance, urgency, and capacity availability. A proprietary, three-phase weight-to-price mapping function ensures pricing fairness while maintaining competitive benchmarks.

In this manner, the system satisfies the long-felt need for a decentralized, user-friendly, and cost-effective logistics solution. The system enables everyday travelers to monetize unused carrying capacity while giving senders access to faster, more affordable delivery. The system integrates smart pricing, real-time tracking, secure payment, and verified identity modules, and introduces a scalable and trusted alternative to conventional shipping methods. The system is suited for urgent deliveries, international gift shipments, startup logistics, and expatriate communities, and may be further adapted for commercial or regulatory-compliant implementations.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system for facilitating peer-to-peer package delivery between a sender and a passenger/traveler/porter. The system comprises a mobile application and a browser-accessible website executing on an electronic computing device, a backend server configured with a microservice architecture, the backend server comprises a user management module configured to register users and assign a role of sender or passenger, a package information module configured to receive flight data from the passenger and package data from the sender, a matching and recommendation module configured to identify a suitable match between the sender and the passenger based on one or more criteria including destination proximity, available luggage space or carrying capacity, and delivery schedule, a communication module configured to enable in-application messaging and push notifications, a payment module configured to facilitate escrow-based financial transactions between the sender and the passenger, and a fraud detection module configured to authenticate users and monitor system access using encrypted communication, IP tracking, and geo-verification.

In another aspect, a computer-implemented method for matching a sender with a passenger/traveler/porter for peer-to-peer parcel delivery is disclosed. The method includes the steps of receiving package details from the sender including pickup location, drop-off location, weight, dimensions, and delivery urgency, receiving travel details from the passenger including flight route, schedule, and available luggage capacity and/or carrying capacity, applying a deterministic rule-based filter to eliminate incompatible passenger profiles, generating a ranked recommendation list using a machine learning algorithm based on one or more historical, spatial, or behavioral factors, and presenting one or more ranked passenger options to the sender for delivery selection.

In another embodiment, the payment module process payments using one or more third-party gateways, support multiple currencies, maintain funds in escrow until delivery confirmation by the sender, and release payments to the passenger upon successful delivery confirmation.

In an embodiment, a peer-to-peer logistics platform for facilitating decentralized package delivery using available luggage space or carrying capacity of passengers or travelers (i.e., airline passengers) is disclosed. The platform includes a client-server architecture including a mobile application and a web-accessible interface configured to enable senders to submit package delivery requests and passengers to register available luggage capacity and/or carrying capacity, a backend system comprises an intelligent pricing engine configured to receive structured and semi-structured inputs from senders, passengers/travelers, and historical data, the pricing engine comprising a multi-phase non-linear pricing function for item weight, including a steep slope for light items, a moderate slope for medium weights, and a price ceiling for heavy items, a quantile regression ensemble output module configured to generate percentile-based pricing predictions bounded by regulatory and competitive constraints, a hybrid neural architecture comprising a graph attention network (GAT) for route clustering, a gated residual network for item characteristic processing, and a temporal convolutional network (TCN) for market demand features, and a multi-objective loss function applied to the pricing model.

In one embodiment, a method for tracking the delivery status of a parcel transported by a passenger/traveler/porter in a peer-to-peer delivery system is disclosed. The method includes the steps of storing a flight record associated with the passenger and linking the record to a parcel, periodically querying external flight tracking APIs to retrieve current flight status, determining a real-time estimated time of arrival (ETA) for the parcel, and displaying flight status updates to the sender using a user interface comprising flight number, departure and arrival locations, flight status, and ETA.

In another aspect, a system for collecting, analyzing, and storing marketplace interaction data in a peer-to-peer logistics platform is disclosed. The system comprises a dual-sided data collection module configured to receive user behavior signals from both senders and passengers/travelers, the signals including offer acceptance thresholds, delivery preferences, and negotiation responses, and storing temporal-spatial pricing trends across a plurality of delivery routes.

In yet another aspect, a computer-implemented pricing recommendation system for peer-to-peer logistics is disclosed. The system comprises a feature ingestion module configured to receive a plurality of input features including route distance, item weight, item category, flight date, available porter capacity, and item value, a non-linear pricing engine configured to apply a multi-phase pricing function based on item weight, the pricing function comprising a first phase for weights between 1-10 pounds with a high rate of price increase, a second phase for weights between 11-30 pounds with a moderate rate of price increase, and a third phase for weights between 31-50 pounds with a flattened pricing rate approaching a ceiling, and a pricing output module configured to generate a recommended delivery fee not exceeding a threshold percentage of a traditional shipping cost for an equivalent route.

In still another embodiment, a quantile regression ensemble is configured to predict at least five percentile values comprising the 10th, 25th, 50th, 75th, and 90th percentiles of the delivery price, a custom activation function is configured to encode a three-phase weight-based price curve within a bounded pricing range, and a layer configured to constrain output values to a competitive ceiling, wherein the pricing ceiling is defined as a percentage threshold of a traditional courier service cost.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a crowd-sourced package delivery system of the present invention in accordance with the disclosed architecture;

FIG. 2 illustrates the login and sign-up user interface of the mobile application of the peer-to-peer package delivery system in accordance with one embodiment of the present invention;

FIG. 3 illustrates the sign-up user interface of the ‘skyporter’ mobile application system designed for new user registration in accordance with one embodiment of the present invention;

FIG. 4 illustrates the Profile Details interface of the ‘skyporter’ mobile application, which is configured to collect essential user identity and contact information in accordance with the present invention;

FIG. 5 illustrates the Know Your Customer (KYC) verification interface of the ‘skyporter’ mobile application, for user authentication and fraud prevention in accordance with the disclosed architecture;

FIG. 6 illustrates an exemplary Passport Photo Capture Interface used in the KYC verification flow within the ‘skyporter’ mobile application in accordance with the disclosed architecture;

FIG. 7 illustrates the Multi-Parameter Filtering Interface of the ‘skyporter’ mobile application, which enables users to locate suitable porters based on several criteria in accordance with the present invention;

FIG. 8 illustrates the map view interface of the ‘skyporter’ mobile application, which enables senders to visually locate available porters based on their current proximity;

FIG. 9 illustrates the Porter Detail and Request Interface of the ‘skyporter’ mobile application in accordance with one embodiment of the present invention;

FIG. 10 illustrates the Order History Interface of the ‘skyporter’ mobile application in accordance with one embodiment of the present invention;

FIG. 11 illustrates the Checkout Interface of the ‘skyporter’ mobile application, which provides users with a detailed summary of their selected delivery prior to payment confirmation;

FIG. 12 illustrates the Parcel Details Interface of the ‘skyporter’ mobile application, showing information elements associated with an active delivery record;

FIG. 13 illustrates the Request Accepted Interface of the ‘skyporter’ mobile application, which is presented to the user immediately after a parcel request has been successfully accepted by a porter;

FIG. 14 illustrates the Request Sent Confirmation Interface of the ‘skyporter’ mobile application, which is displayed to the user after a delivery request has been successfully submitted to a porter;

FIG. 15 illustrates the Porter Mode Travel Entry Interface of the ‘skyporter’ mobile application, designed to enable a porter to input travel details and declare available luggage space or carrying capacity;

FIG. 16 illustrates the Porter Mode Active Trip Overview Interface of the ‘skyporter’ mobile application, which displays currently active or upcoming travel entries submitted by the user in the porter role;

FIG. 17 illustrates the Administrative Dashboard Interface of the ‘skyporter’ portal system in accordance with one embodiment of the present invention;

FIG. 18 illustrates an embodiment of the Fraud Detection Module of the ‘skyporter’ system configured to perform automated identity verification and fraud prevention;

FIG. 19 illustrates a Smart Pricing Mechanism incorporated within the ‘skyporter’ platform, which dynamically determines a recommended delivery price based on multiple contextual parameters;

FIG. 20 illustrates a Visual Package Verification workflow implemented within the ‘skyporter’ platform to ensure the physical integrity, accuracy, and compliance of packages;

FIG. 21 illustrates a flowchart depicting a process for implementing a Smart Pricing Mechanism Flow in accordance with one embodiment of the present invention;

FIG. 22 illustrates a comprehensive system architecture diagram of the ‘skyporter’ ID Verification and Document Scanning Module in accordance with one embodiment of the present invention;

FIG. 23 illustrates a flowchart of a machine learning-based Pricing Recommendation in accordance with one embodiment of the present invention; and

FIG. 24 illustrates a schematic neural network architecture diagram showing a hybrid deep learning model used for intelligent pricing prediction in the present invention, as per one embodiment.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a peer-to-peer international package delivery system that overcomes the cost, delay, and inflexibility inherent in conventional shipping services. There is a long-felt need for a system that enables individuals to send packages internationally or domestically with greater speed, affordability, and transparency. Additionally, there is a long-felt need for a delivery model that offers real-time tracking, dynamic pricing, and secure communication between the sender and the courier. There is also a long-felt need for a system that harnesses underutilized travel capacity, particularly airline luggage space or carrying capacity. Furthermore, there is a long-felt need for a delivery solution that incorporates AI-driven matching, robust identity verification, and intelligent pricing algorithms to ensure fairness, efficiency, and trust throughout the logistics process. Finally, there is a long-felt need in the art for a package delivery system that enables passengers to receive discounts or monetary incentives for transporting packages and offers a fast-shipping solution for international packages.

The present invention, in one exemplary embodiment, is a computer-implemented method for matching a sender with a passenger/traveler/porter for peer-to-peer parcel delivery. The method includes the steps of receiving package details from the sender including pickup location, drop-off location, weight, dimensions, and delivery urgency, receiving travel details from the passenger including flight route, schedule, and available luggage capacity and/or carrying capacity, applying a deterministic rule-based filter to eliminate incompatible passenger profiles, generating a ranked recommendation list using a machine learning algorithm based on one or more historical, spatial, or behavioral factors, and presenting one or more ranked passenger options to the sender for delivery selection.

Reference will now be made in detail to the present preferred embodiments of the invention, examples of which are illustrated in the accompanying drawings. Wherever possible, the same reference numerals are used in the drawings and the description to refer to the same or like parts.

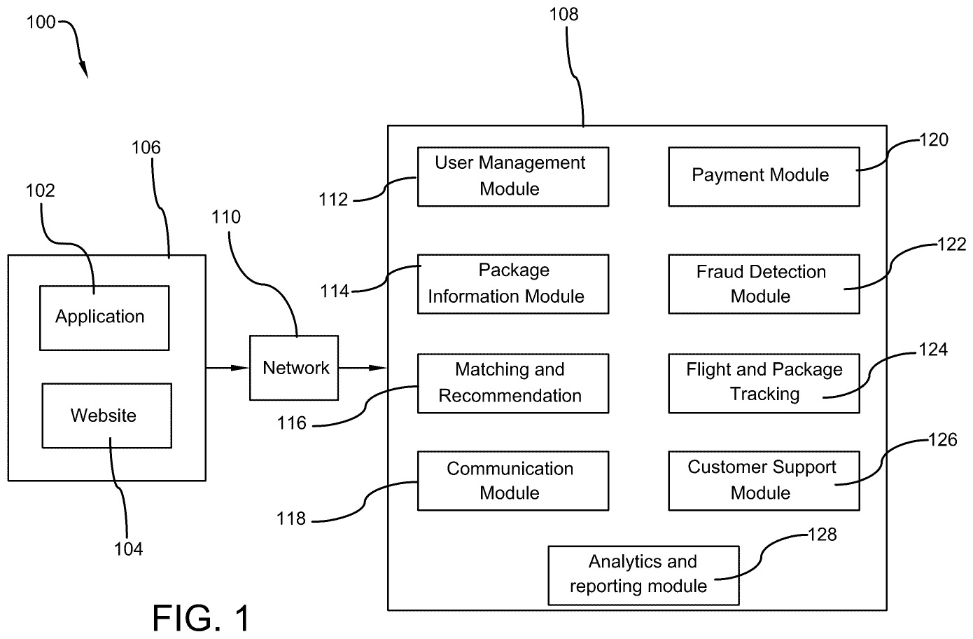

Referring initially to the drawings, FIG. 1 illustrates a schematic view of crowd sourced package delivery system of the present invention in accordance with the disclosed architecture. The crowd sourced package delivery system 100 of the present invention is also referred to as ‘skyporter’ in the present disclosure and is designed to facilitate peer-to-peer logistics by connecting individuals who wish to send packages (hereinafter “senders”) with airline travelers (hereinafter “passengers”) who have unused luggage space/carrying capacity and are traveling to the same or similar destination. The system 100 uses unused capacity in personal travel luggage to provide a cost-effective, efficient, and secure method of transporting small to medium-sized items across domestic and international locations.

The system 100 preferably has a client-server architecture and enables access of the system 100 using a mobile application 102 or a browser-accessible website 104. Both the mobile application 102 and the website 104 provide the same functionality and access to the system 100 through an electronic computing device 106 such as a smartphone, laptop, and the like.

Examples of the electronic computing device 106 may include, but are not limited to, a desktop, a notebook, a laptop, a handheld computer, a touch sensitive device, a computing device, a smart-phone, and/or a smart watch. It will be apparent to a person of ordinary skill in the art that the electronic computing device 106 may include any device/apparatus that is capable of manipulation by the user

A backend server 108 accessible using a network 110 provides the functionality for facilitating crowd-sourced delivery system and includes a plurality of modules and preferably has a microservice architecture. A user management module 112 included in the server 108 handles user registration, user authentication, and profile management of users. More specifically, upon registration of a user, a role assignment of either a sender or passenger is performed for the user. As described later in disclosure, verification using an identification document, travel document, and more is also performed for the users. A package information module 114 manages the information related to user travel data and sender package. More specifically, the package information module 114 provides interfaces for providing flight information, package details and luggage space/carrying capacity availability.

A matching and recommendation module 116 algorithmically connects senders with passengers based on package requirements and flight details. The module 116 may integrate deterministic logic (rules-based filtering) and machine learning (predictive ranking and personalization) to provide real-time, accurate, and trust-optimized match suggestions. The module 116 may use information such as pickup and delivery location of the package, desired delivery window, package weight and dimensions, and package type (fragile, urgent, etc.) provided by a sender.

The module 116 may also use information such as flight route and schedule, available luggage space/carrying capacity, and preferences to carry item types, from different passengers. The module 116 also includes information such as historical delivery performance of passengers/travelers, geographical proximity between the sender and the passenger for matching senders and passengers. The matching and recommendation module 116 may also be trained to rank and recommend the most suitable passengers to each sender.

A communication module 118 enables secure communication between users within the application 102 and may provide an in-app messaging interface along with features for media sharing to upload images of a package and a push notification mechanism to provide real-time updates about a package delivery. A payment module 120 is configured to manage all financial transactions between the senders and the passengers. The payment module 120 may support multiple currency transactions and can integrate various third-party gateways such as Stripe® and PayPal®. The payment module 120 also supports escrow handling which holds funds until confirmation by a sender.

A fraud detection module 122 enables secure communication and transactions in the system 100. The module 122 implements encrypted access to the system 100 using SSL/TLS encryption and may implement advanced security mechanism including but not limited to IP address tracking and Geo-verification.

A flight and package tracking module 124 continuously monitors the progress of a passenger/traveler/porter's journey and updates the sender on the status of their package. The flight and package tracking module 124 integrates real-time flight tracking services (FlightAware, FlightRadar24, or OpenSky, and more) and a plurality of APIs are used to pull real-time data on flight number, current status (on time, delayed, in air, landed), and ETA (Estimated Time of Arrival). The module 124 provides an automated package visibility system. Specifically, when a passenger/traveler/porter registers their flight, it is stored in the system and linked to the package and the module 124 uses the flight number and departure/arrival airport codes to poll flight status at regular intervals (e.g., every 10-15 minutes).

A customer support module 126 assists users (both senders and passengers/travelers) by providing support for issues ranging from technical problems and package disputes to payment queries and account assistance. The module 126 may provide a support ticket mechanism, live chat, and a self-service FAQ center. The support ticket mechanism enables users to report issues related to account access, payment processing, delivery problems, or general inquiries. Users can submit tickets directly through the web or mobile interface, specifying the category of the issue, relevant package or transaction identifiers, and descriptive details.

To provide real-time assistance, live chat functionality is offered, to help in time-sensitive scenarios such as missed package handovers, last-minute travel changes, or payment disputes. The chat system may use a chatbot that attempts to resolve common issues or gather initial context, and unresolved queries can be escalated to a live agent.

An analytics and reporting module 128 provides essential data-driven insights for both users and system administrators, facilitating transparency, performance monitoring, and continuous platform optimization. The reporting module 128 is designed to perform transaction tracking, performance metrics, and user behavior analysis. The reporting module 128 is configured to record and generate detailed reports for each user regarding their financial and operational activity on the platform. For senders, the system 100 provides a historical log of packages sent, delivery status, associated costs, and timestamps.

For passengers/travelers, the system 100 compiles a record of packages carried, earnings accrued, payment status, and service fees deducted. The reporting module 128 further records user ratings and feedback, which are aggregated and analyzed to assess user reliability, satisfaction, and consistency over time. The data is used internally to enhance the accuracy of the matching algorithm and to inform decisions related to user ranking, recommendation, and eligibility.

The reporting module 128 also monitors engagement patterns and interaction flows within the application. By analyzing metrics such as time spent on the platform, frequency of match rejections or cancellations, communication patterns, and user retention rates, the system derives behavioral trends that are used to optimize the user experience.

The communication network 110 may include suitable logic, circuitry, and interfaces that may be configured to provide a plurality of network ports and a plurality of communication channels for transmission and reception of data related to operations of various entities of the system 100. Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network 110 may be associated with an application layer for implementation of communication protocols based on one or more communication requests.

The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term Evolution (LTE) communication protocols, or any combination thereof.

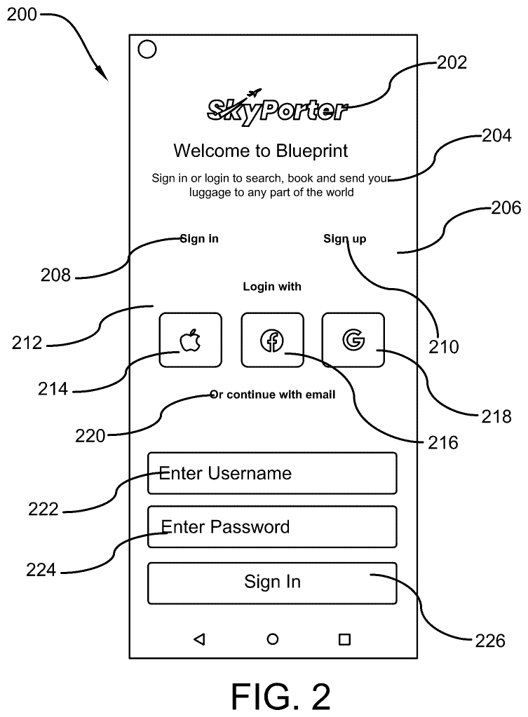

FIG. 2 illustrates the login and sign-up user interface of the mobile application of peer-to-peer package delivery system, as disclosed in the present invention. The interface 200 comprises a structured layout designed for both first-time users and returning users, offering multiple authentication options and ensuring user accessibility and platform security. The interface 200 includes an application name and logo 202, incorporating visual branding with, for example, an aviation theme to indicate the travel-oriented functionality of the system.

A welcome message 204 to introduce users to the system 100 and summarizing the core purpose namely, enabling users to search, book, and send luggage globally using peer-to-peer connections is displayed. A tab-based navigation bar 206, which includes a selectable “Sign in” tab 208 and a “Sign up” tab 210 is displayed. The active tab is visually emphasized to indicate the current mode of interaction.

In the primary authentication section, users are presented with third-party login options 212, which include icon-based buttons for different third-parties including but not limited to Apple 214, Facebook 216, and Google 218 login. The interface includes a separator label “Or continue with email” 220, guiding users toward manual login and includes a username input field 222 and a password input field 224. At the bottom of the interface, a primary action button 226 labeled “Sign in” is provided, which triggers the authentication function upon entry of valid credentials.

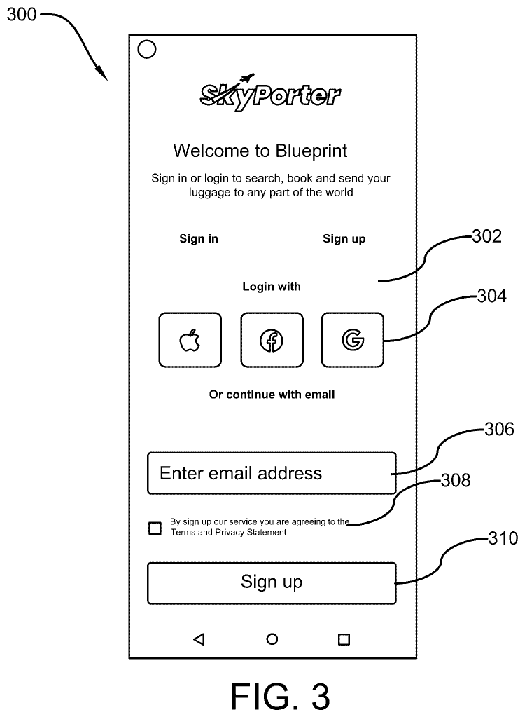

FIG. 3 illustrates the sign-up user interface of the ‘skyporter’ or ‘porter’ mobile application system, designed for new user registration using either third-party identity providers or manual email input. The interface 300 provides a plurality of authentication pathways and displays a third-party sign-up area 302 that enables users to register using external identity providers 304. An alternative sign-up method invites users to continue registration using their email address. A single-line input field 306 enables users to enter a valid email address to initiate account creation.

A terms and privacy consent section 308 is displayed, containing a checkbox for the user to confirm agreement with the application's Terms of Service and Privacy Policy. This compliance step enables adherence to data protection and user agreement requirements. A “Sign up” button 310 is provided and when activated, the button 310 processes the email registration or redirects to a password setup/verification flow.

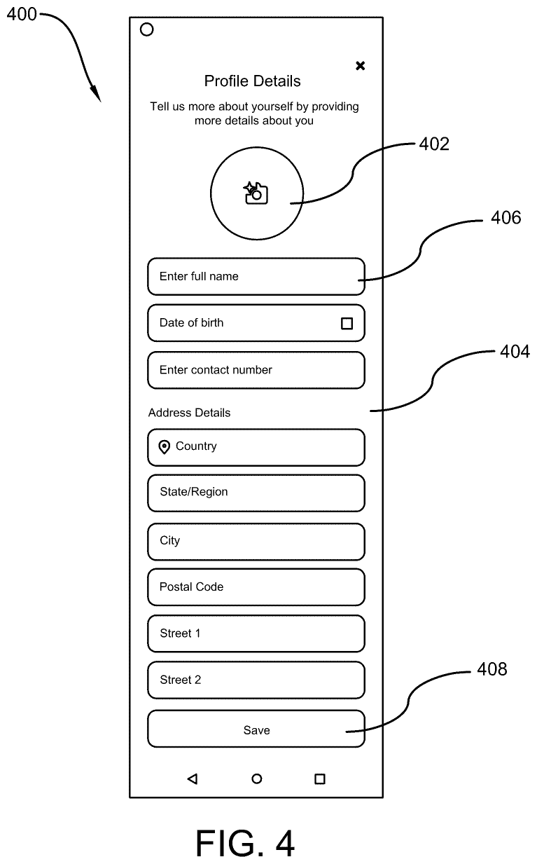

FIG. 4 illustrates the Profile Details interface of the ‘skyporter’ mobile application, which is designed to collect essential user identity and contact information as part of the registration and verification workflow. The interface 400 provides a profile picture placeholder 402, enabling users to upload or capture a profile image. A structured data entry form 404 comprising multiple input fields for personal and address details is displayed which includes a plurality of text boxes 406 to collect user's legal name, date of birth, a mobile or landline number, country, state, postal code, and other address details. A confirmation button 408 labeled “Save”, is provided which submits the entered data to the system 100 for storage and potential verification.

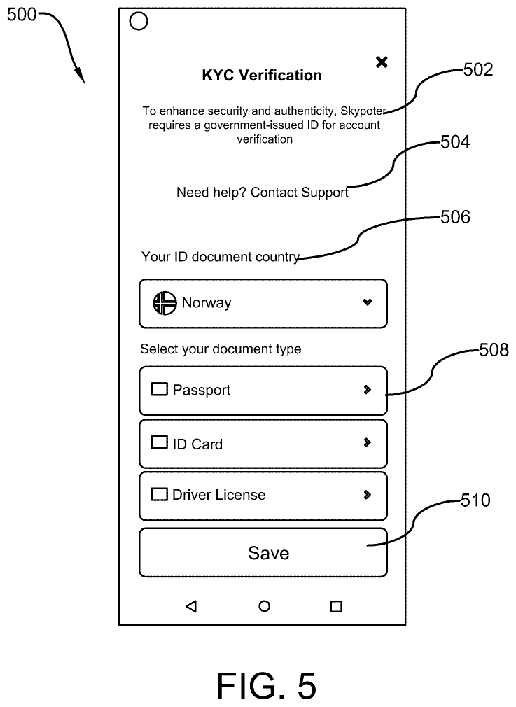

FIG. 5 illustrates the Know Your Customer (KYC) verification interface of the ‘skyporter’ mobile application, for user authentication and fraud prevention in accordance with the disclosed architecture. The interface 500 supports identity validation and regulatory compliance by collecting user-selected document types and issuing country information. The interface 500 displays an instructional message 502 informing users of the necessity of completing the KYC step for security.

A support prompt 504 is displayed which provides a link labeled “Support”, which redirects users to assistance resources. A dropdown control labeled “Your ID document country” 506 is displayed which can be used for selecting and displaying a country. A menu offering a plurality of documents 508 is displayed wherein a document label can be selected to proceed to the capture or upload stage in the document submission process. At the bottom of the interface is a submission control 510, which is initially displayed in a disabled state and labeled “Save”. The control becomes enabled only after valid selections are made for both the country and the document type, ensuring that incomplete inputs cannot be submitted.

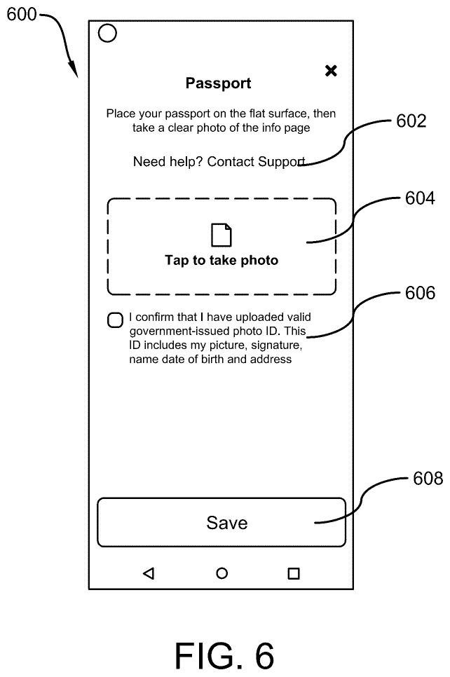

FIG. 6 illustrates an exemplary Passport Photo Capture Interface used in the KYC (Know Your Customer) verification flow within the ‘skyporter’ mobile application in accordance with the disclosed architecture. The interface 600 displays a help prompt 602, including the phrase “Need help? Contact Support,” with the word “Support” rendered as a tappable link. The link routes users to assistance resources, enabling them to get help in real-time if they encounter any issues during document capture. A document image capture element 604 is displayed and when the user taps the element 604, the device's camera is activated, and the user is prompted to capture a high-resolution image of the passport's identification page.

A confirmation checkbox 606 is presented alongside a statement indicating user acknowledgment and the checkbox must be selected to activate the submission control and confirms the user's compliance with documentation requirements and the platform's verification standards. At the bottom of the interface 600, a submission button 608 labeled “Save” is shown in a disabled state by default. The button is only enabled once a valid photo has been captured and the acknowledgment checkbox is selected.

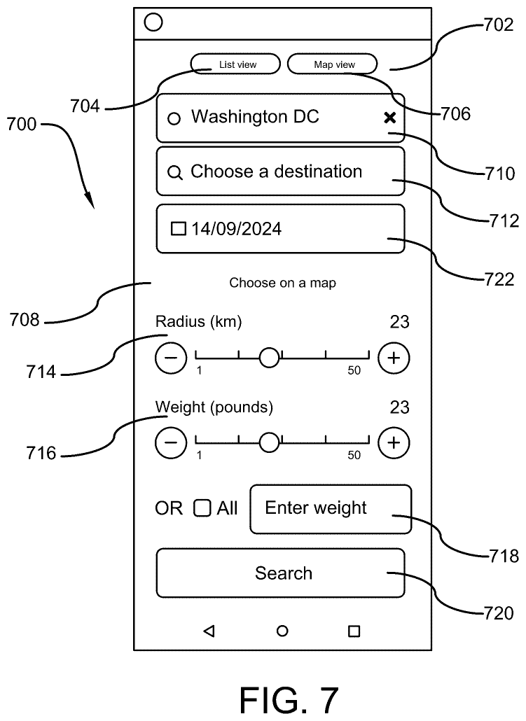

FIG. 7 illustrates the Multi-Parameter Filtering Interface of the ‘skyporter’ mobile application, which enables users to locate suitable porters based on geographic proximity, destination preferences, and available luggage capacity and/or carrying capacity. The interface 700 includes a view selection toggle 702 featuring two options including a list view 704 and a map view 706. A main filter panel 708 includes several search criteria fields including an Origin location field 710, which is populated with “Washington DC” in the illustrated example, representing the user's current or selected starting point. A destination search bar 712, labeled “Choose destination,” enables entry or selection of the desired delivery endpoint. The search bar 712 includes a search icon to reinforce input interactivity.

The interface 700 displays two range selector sliders for numeric filters including a radius selector 714 labeled “Radius (km)”, with a slider and discrete increment buttons. In the example, the selected value is 23 kilometers. A weight selector 716 labeled “Weight (pounds)”, is also equipped with a slider and plus/minus adjustment controls. The current selection is 23 pounds. The dynamic sliders enable users to define the distance they are willing to travel for a handoff and the package weight a porter must accommodate. Beneath the sliders, an alternative manual entry field 718 is included, where users can enter a custom weight value. A search execution button 720 labeled “Search”, when tapped initiates the backend matching logic to find porters using the parameters set by a user.

It should be noted that a Date Picker Field 722 is included to enable users to specify a desired delivery or travel date, further refining the search for compatible porters. The date field enables the system to filter porters who are available or traveling on the specified date and improve match precision based on schedule compatibility.

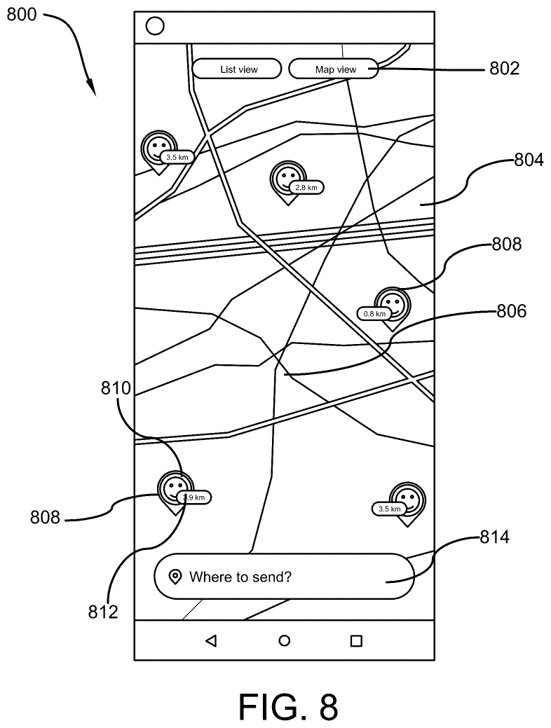

FIG. 8 illustrates the map view interface of the ‘skyporter’ mobile application, which enables senders to visually locate available porters (i.e., travelers) based on their current proximity. At the top of the interface 800, a view toggle control 802 is displayed, enabling users to switch between a list view and a map view. A digital map 804 displays user's current location 806, indicated by a dot with a radial zone surrounding it. A plurality of porter markers 808, each represents a profile photo 810 of the porter and a numeric label 812 indicating the distance in kilometers between the porter and the user. Each porter marker corresponds to a registered porter currently available to carry a package. At the bottom of the screen is a destination entry field 814, labeled “Where to send?”, which invites the user to input or select the desired delivery destination. This field filters out irrelevant porters and triggers the route-matching algorithm.

The interface 800 also supports interactive map functions, such as pinch-to-zoom, marker tapping for more details, and map dragging to view other regions. The interface 800 also provides real-time spatial awareness of available porters in the user's vicinity and contributes to a faster, more user-friendly match experience.

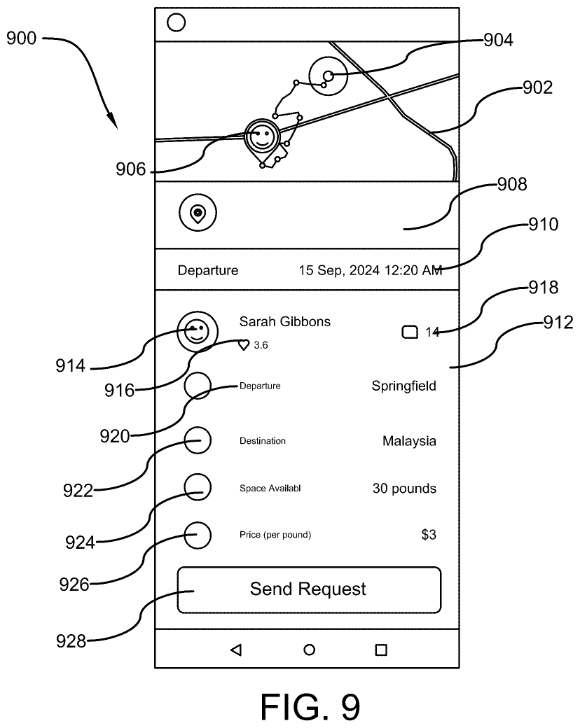

FIG. 9 illustrates the Porter Detail and Request Interface of the ‘skyporter’ mobile application in accordance with one embodiment of the present invention. A map preview section 902 displays a partial geographic map centered on the user's current location 904 and the selected porter's location 906. The interface 900 displays the drop destination 908 labeled as “Luggage Drop Destination”. A departure time 910, indicated as “15 Sep. 2024 12:20 AM.” is also displayed. The timestamp helps users evaluate whether the porter's timeline aligns with their delivery requirements. A central profile section 912 features the porter's identity and activity metrics including but not limited to porter name and photo 914, user rating 916, number of completed deliveries 918, departure location 920, destination 922, available space 924, and price per unit 926. At the bottom of the screen is a call-to-action button 928 labeled “Send Request,” when activated, initiates a delivery proposal from the sender to the porter.

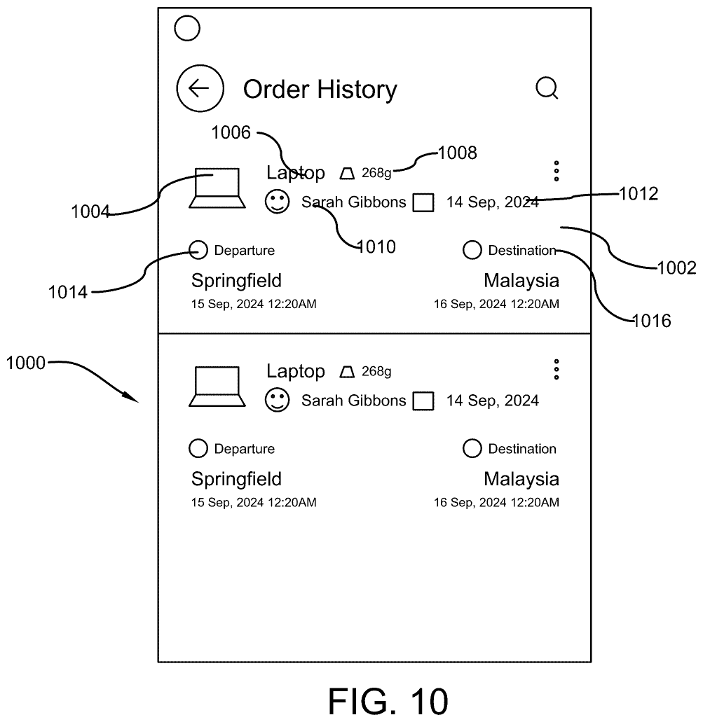

FIG. 10 illustrates the Order History Interface of the ‘skyporter’ mobile application in accordance with one embodiment of the present invention. The interface 1000 enables users to view a chronological list of their previously completed or scheduled deliveries. Each historical order is presented as an individual order card 1002 and each card includes a thumbnail image 1004 (e.g., a laptop) representing the delivered item, followed by the item name 1006 (e.g., “Laptop”) and weight 1008 (e.g., 268g) displayed with a scale icon. The porter's profile image 1010, and the order date 1012 are shown to indicate the assigned carrier and transaction date. The interface 1000 also displays departure information 1014 including location and time and displays destination information 1016 including location and time.

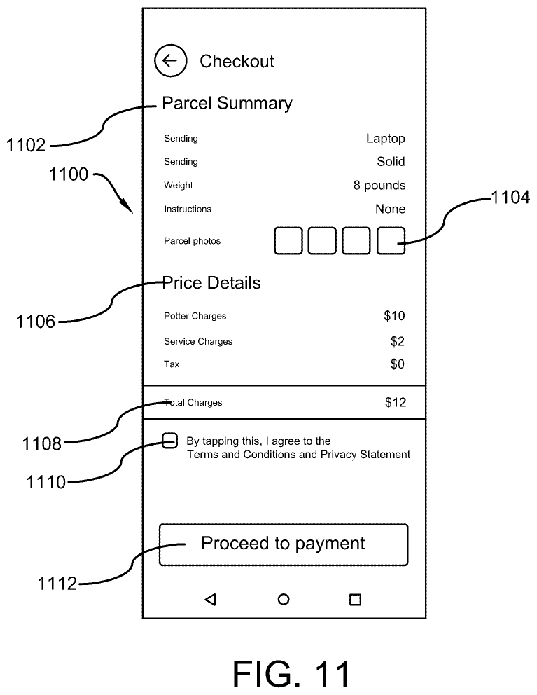

FIG. 11 illustrates the Checkout Interface of the ‘skyporter’ mobile application, which provides users with a detailed summary of their selected delivery prior to payment confirmation. The interface 1100 enables the sender to review the parcel details and associated cost components. A parcel summary section 1102 is presented and the section includes structured information such as the item being sent (in this example, a “Laptop”), the type of material (noted as “Solid”), the weight of the package (stated as “8 pounds”), and any special instructions entered by the user (here indicated as “None”). Additionally, the interface displays a row of parcel photos 1104, which serve as visual documentation of the package condition and appearance.

The interface 1100 displays a Price Details section 1106. The section 1106 itemizes the individual cost components of the transaction and shows the porter's delivery fee, the Service Charges field (reflects the fee retained by the ‘skyporter’ platform for facilitating the match and transaction), and the tax liability, which is displayed as $0 in this example. A calculated Total Charges line 1108 summarizes the final payable amount, here totaling $12.

At the bottom of the interface 1100, a confirmation checkbox 1110 is presented, requiring the user to agree to the platform's Terms & Conditions and Privacy Statement before proceeding. Below the checkbox, a “Proceed to Payment” button 1112 enables the user to move forward with payment processing.

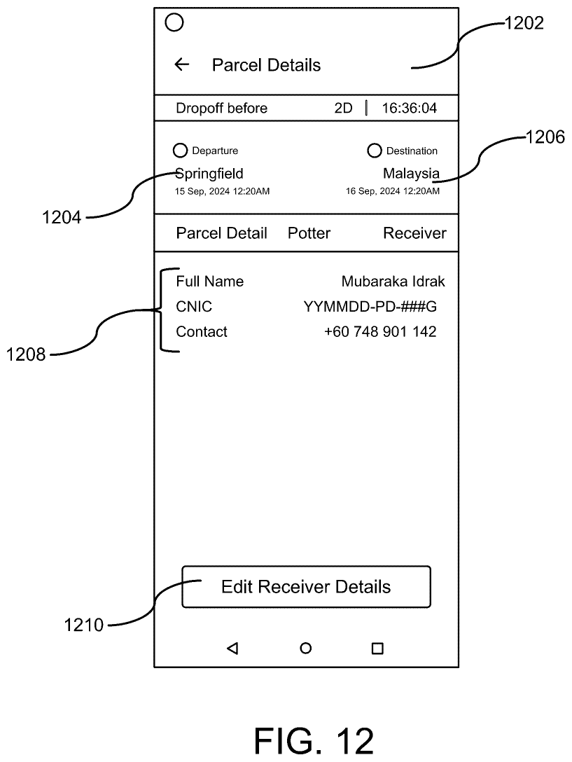

FIG. 12 illustrates the Parcel Details Interface of the ‘skyporter’ mobile application, showing information elements associated with an active delivery record. A parcel identifier 1202, displays a unique transaction number (e.g., “#1900339658”) that serves as the shipment's reference for tracking, support, or auditing purposes. The departure details 1204 includes the departure location (“Springfield”) and the scheduled departure time (“15 Sep. 2024, 12:20 AM”). The interface 1200 also displays the destination information 1206 including location and time, indicating that the parcel is to be delivered in “Malaysia” by the expected arrival time of “16 Sep. 2024, 12:20 AM in the present example. A receiver's contact information 1208 includes the full name of the recipient (e.g., “Mubaraka Idrak”), a masked national identity number (CNIC), and a contact telephone number. The information enables the delivery to be matched to a verified and reachable recipient, supporting both trust and compliance objectives. A call-to-action element 1210 shown as the “Edit Receiver Details” button enables the sender to update or correct the recipient's details before finalizing the handoff.

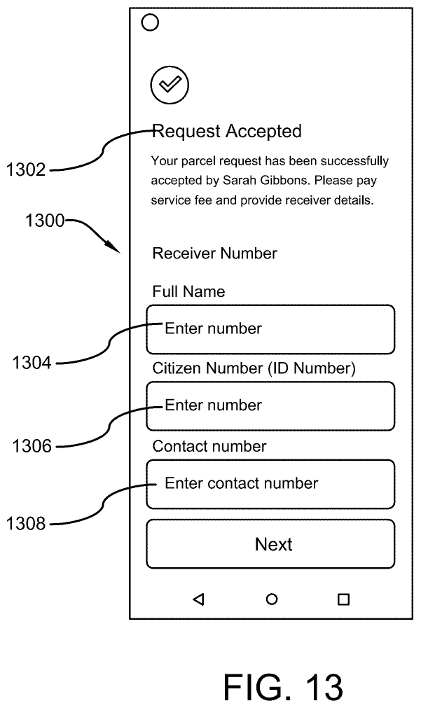

FIG. 13 illustrates the Request Accepted Interface of the ‘skyporter’ mobile application, which is presented to the user immediately after a parcel request has been successfully accepted by a porter. The message display section 1302, confirms acceptance with the text “Request Accepted,” followed by a sub-message indicating the name of the accepting porter (e.g., Sarah Gibbons) and providing instructions to pay the service fee and submit receiver details.

The interface 1300 includes a Receiver Details input form, composed of a structured set of text fields. The first input field, labeled 1304, is designated for the receiver's full name and includes a placeholder instructing the user to “Enter name.” The second field 1306, captures the receiver's government-issued identification number. The third field 1308, is used to input the receiver's contact phone number, indicated by the label “Contact number” and a corresponding placeholder for number entry.

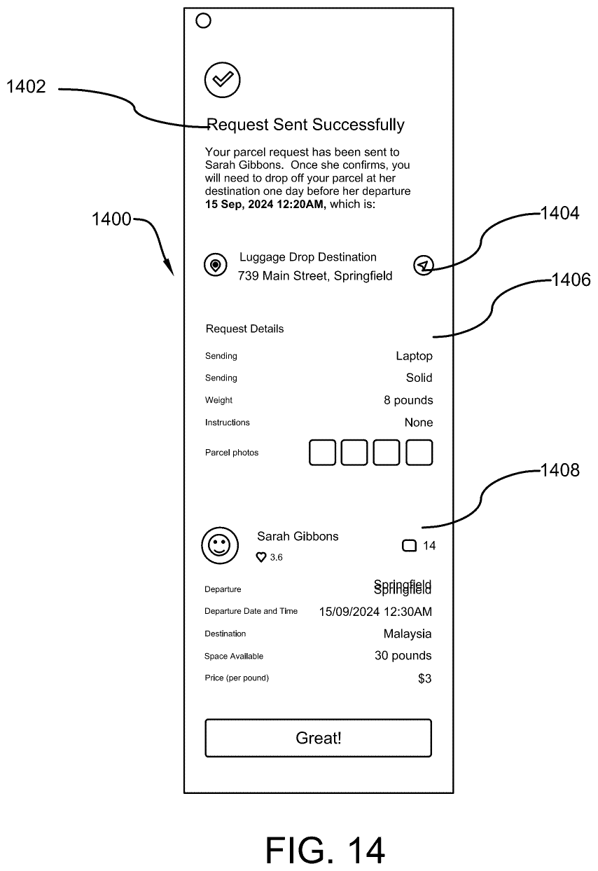

FIG. 14 illustrates the Request Sent Confirmation Interface of the ‘skyporter’ mobile application, which is displayed to the user after a delivery request has been successfully submitted to a porter. The interface 1400 provides confirmation of request submission, delivery instructions, and an overview of the relevant parcel and porter information. A confirmation message 1402 notifies the user that the parcel request has been sent to a designated porter and indicates that a drop-off at the specified destination (i.e., porter's designated address) will be required within a defined time window. The section includes a scheduled drop-off deadline highlighted for user emphasis. The drop-off can be in person by the sender where the sender and traveler/porter are within a reasonable geographic proximity. In other situations, the drop-off can be through another or third-party. The another or third-party can be a delivery service or delivery request (i.e., via Amazon™) made at the time of ordering the parcel or product. It is to be appreciated that the drop-off address or location can be designated at the time the sender orders a product and then ‘designates’ (i.e., ‘ship to’) the address of the porter as the specified destination.

The interface displays a location field 1404, which shows the designated luggage drop destination. The area may include interactive elements, such as icons or tooltips, enabling the user to access map functionality or additional contextual information about the location.

A Request Details section 1406, presents structured information about the parcel being sent, including item type, material classification, item weight, optional delivery instructions, and a set of parcel photographs. The details help ensure accurate delivery, condition verification, and compliance with platform protocols. A Porter Details section 1408, displays summary information about the porter who will carry the parcel. The section includes identification information, departure and destination locations, scheduled departure time, available carrying capacity, and the cost per unit of weight.

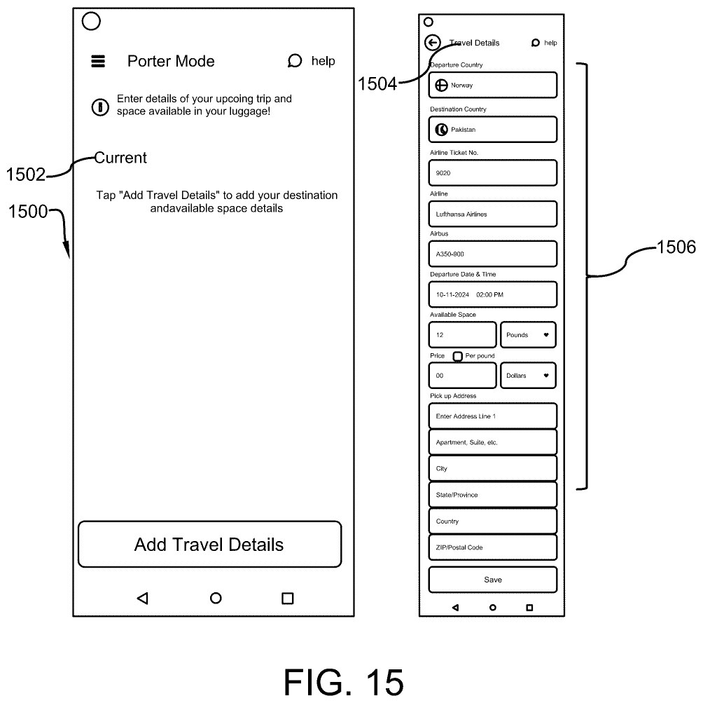

FIG. 15 illustrates the Porter Mode Travel Entry Interface of the ‘skyporter’ mobile application, designed to enable a user acting in the role of a porter to input details of an upcoming trip and declare available luggage space/carrying capacity for package transport. The interface 1500 displays a prompt for users to enter travel details. A status area labeled 1502 includes instructional text that guides the user to tap the button below to begin entering their destination and available space data. A Travel Details Form 1504 includes a plurality of fields for travel details and include placeholders for departure country, destination country, airline ticket number, airline name, aircraft model, and departure date and time. Additionally, the form includes entry fields for the available luggage space/carrying capacity (specified in weight units), the price per unit of space, and a complete pickup address, including line items for street, apartment, city, state or province, country, and postal code.

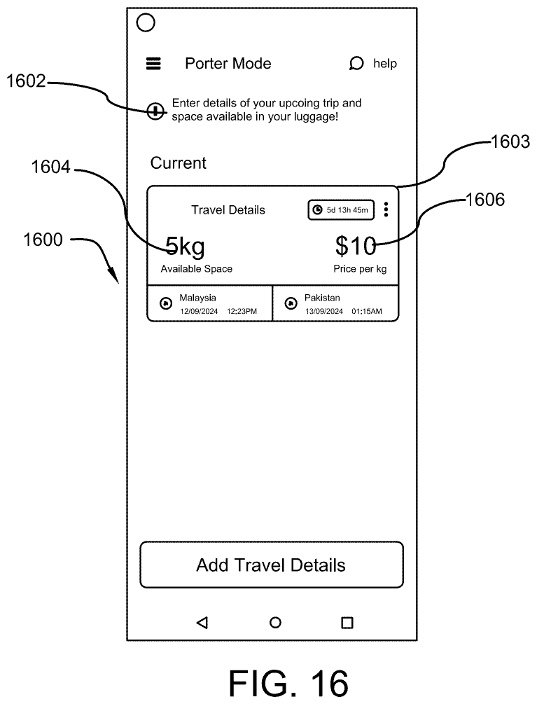

FIG. 16 illustrates the Porter Mode Active Trip Overview Interface of the ‘skyporter’ mobile application, which displays currently active or upcoming travel entries submitted by the user in the porter role. The interface 1600 includes a header section 1602 includes the title “Porter Mode” and displays instructional text prompting the user to enter details of an upcoming trip and available luggage space/carrying capacity. A summary card 1603 represents one active travel listing. The card includes structured data such as the available space 1604 for carrying packages (e.g., shown in weight units) and a countdown timer indicating the time remaining before departure. The field 1606 displays the price per unit of weight set by the porter for carrying luggage.

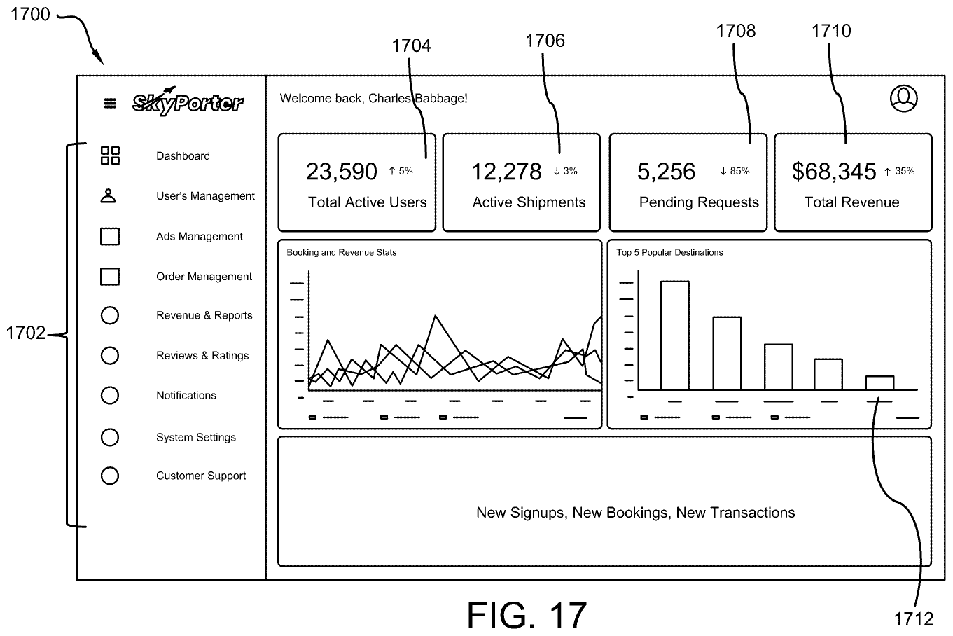

FIG. 17 illustrates the Administrative Dashboard Interface of the ‘skyporter’ portal system in accordance with one embodiment of the present invention. The interface 1700 provides a centralized environment for administrative users to monitor, manage, and evaluate operational metrics across the platform. The interface 1700 includes a plurality of navigational menus 1702 which contains links to various management modules, including Users Management, Ads Management, Order Management, Revenue & Reports, Reviews & Ratings, Notifications, System Settings, and Customer Support.

The interface 1700 displays “Total Active Users” metric 1704, which shows the count of users currently registered and active on the platform. The “Active Shipments” metric 1706 and reflects the number of ongoing parcel deliveries. The “Pending Requests” count 1708 represents unconfirmed or unfulfilled service actions. The “Total Revenue” card 1710, also part of the summary panel, provides a cumulative financial metric reflecting income generated through platform transactions.

A graphical data panel 1712 displays real-time analytics and shows booking and revenue trends over time using multi-line visualizations for metrics such as bookings, revenue, and cancellations. The panel 1712 also presents a bar chart indicating the top five popular destinations, plotted against variables such as frequency of bookings, revenue, and cancellations.

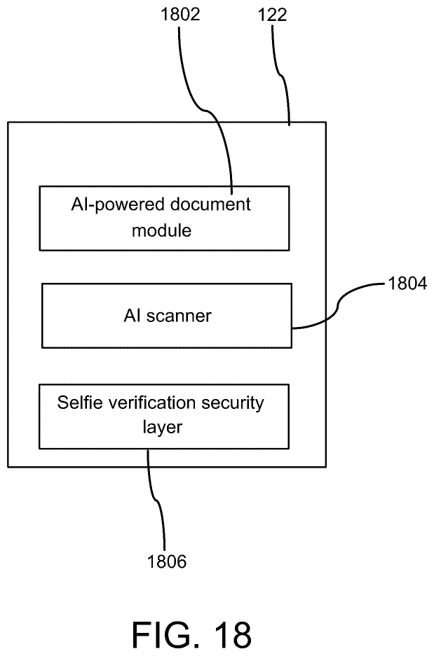

FIG. 18 illustrates an embodiment of the Fraud Detection Module 122, which is configured to perform automated identity verification and fraud prevention functions within the ‘skyporter’ system. The module includes an AI-powered document module 1802, which manages the processing of user-submitted identity documents, such as passports or national ID cards. An AI scanner 1804 utilizes optical character recognition (OCR) techniques in combination with machine learning-based validation algorithms to extract, interpret, and confirm the authenticity of document data.

In conjunction with document scanning, the fraud detection module further includes a selfie verification security layer 1806, which serves as a biometric verification mechanism. The layer is configured to compare a user-captured facial image against the verified identification document image to authenticate the user's identity and prevent impersonation or synthetic identity fraud. The combined operation of the components enables real-time, secure user onboarding and provides a foundational security framework for the platform's trust and safety infrastructure.

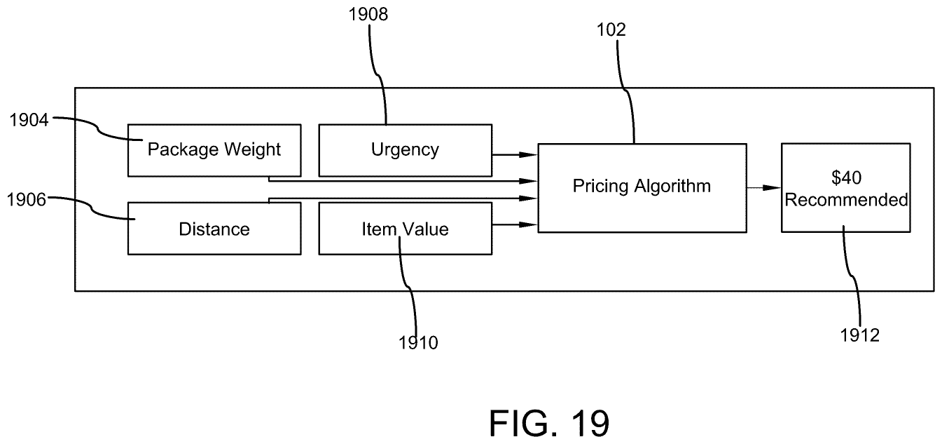

FIG. 19 illustrates a Smart Pricing Mechanism incorporated within the ‘skyporter’ platform, which dynamically determines a recommended delivery price based on multiple contextual parameters. The system 100 employs a Pricing Algorithm 1902 that receives and processes a set of input variables, including package weight, distance, urgency, and item value. Each of these input factors contributes to the computational model that drives pricing logic.

The package weight input 1904 reflects the mass or volume of the item to be delivered, which impacts the porter's carrying load and resource use. The distance parameter 1906 defines the geographic span between the pickup and drop-off locations, influencing travel time, fuel consumption, and logistical effort. The urgency input 1908 captures the time sensitivity of the delivery, with higher urgency often necessitating expedited transport or priority handling. The item value input 1910 accounts for the declared worth of the parcel contents, which may influence risk considerations, liability, and handling requirements.

The parameters are fed into the Pricing Algorithm 1902, which performs real-time computations to derive a fair, context-aware pricing recommendation. The output of the algorithm is a recommended price 1912, displayed to the sender for review and approval (e.g., “$40”), although the actual value is determined dynamically per transaction.

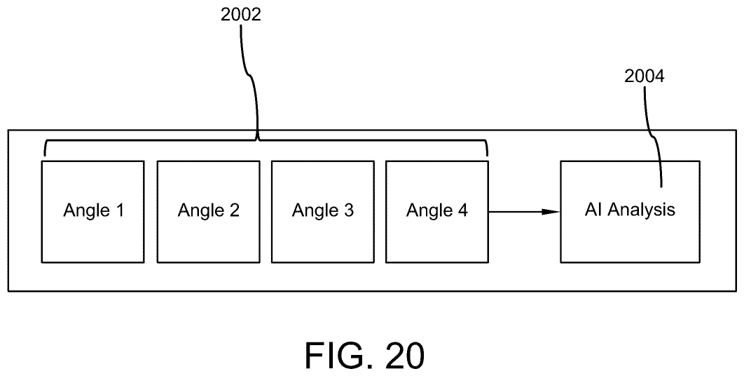

FIG. 20 illustrates a Visual Package Verification workflow implemented within the ‘skyporter’ platform to ensure the physical integrity, accuracy, and compliance of packages submitted for delivery. The workflow is configured to analyze multiple visual inputs to validate that the parcel contents conform to platform standards and user-declared information. The process begins with the acquisition of a plurality of package images 2002 from multiple predefined viewpoints, represented as Angle 1, Angle 2, Angle 3, and Angle 4, as non-limiting examples. The views may include top, bottom, front, side, or diagonal captures of the parcel to provide comprehensive visual coverage. The collected images are submitted to an AI Analysis module 2004, which performs delivery assessment by comparing and evaluating key visual features such as shape, packaging integrity, labeling, and potential signs of damage or tampering. The AI engine may utilize techniques such as object detection, anomaly detection, and computer vision-based pattern recognition to assess the authenticity, safety, and compliance of the item.

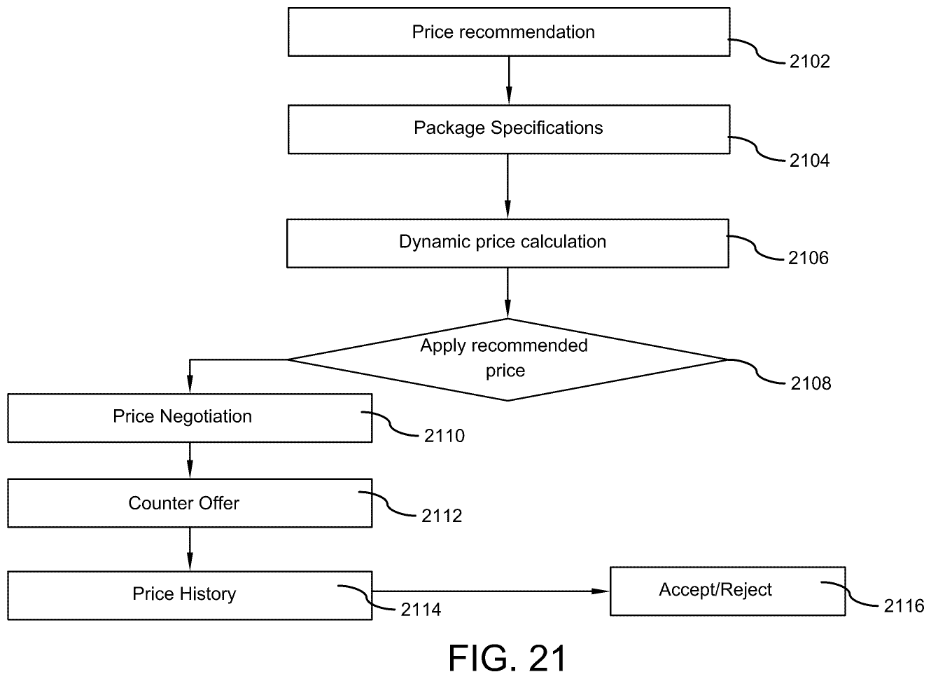

FIG. 21 illustrates a flowchart depicting a process for implementing a Smart Pricing Mechanism Flow in accordance with one embodiment of the present invention. Initially, a user inputs parcel details such as weight, dimensions, value, delivery urgency, and destination (Step 2102). Upon entering this information, the platform processes the inputs and calculates a recommended price in real time, which is displayed to the user along with comparable market pricing for reference (Step 2104).

The system then presents the user with the option to apply the recommended price directly using a single-tap control (Step 2106). If the user agrees with the suggested price, the process proceeds directly to the payment or booking confirmation step.

Alternatively, if the user chooses to negotiate, the system transitions into a Price Negotiation Flow (Step 2108). In the flow, sender and porter may propose a modified price, and the system visualizes price history, displaying previous offers and responses in a clear timeline format (Step 2110). Upon submission of a new price, the counterparty is prompted with accept or reject options, accompanied by confirmation dialogs to prevent unintended actions (Step 2112). Once the negotiation concludes with an accepted price, the agreed value is applied, and the transaction moves to the final confirmation stage (Step 2114).

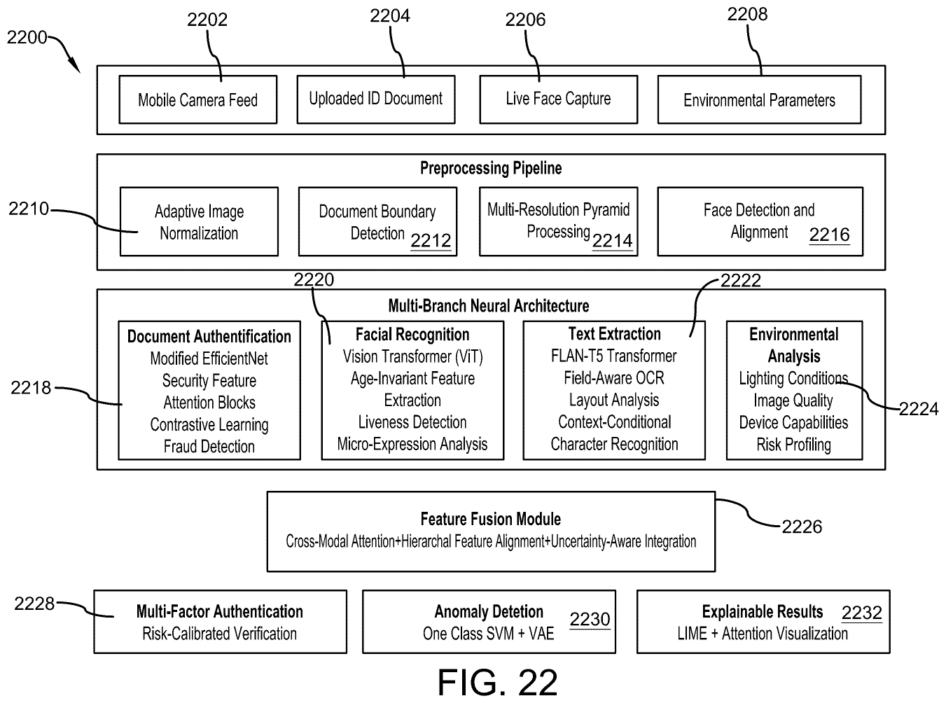

FIG. 22 illustrates a comprehensive system architecture diagram of the ‘skyporter’ ID Verification and Document Scanning Module, generally designated as 2200. The architecture is designed to enable secure, automated identity verification using multimodal inputs, AI-driven analysis, and explainable decision-making. A multi-input acquisition layer collects data from various sources including a mobile camera feed 2202, uploaded ID document 2204, live face capture 2206, and associated environmental parameters 2208 (e.g., lighting, device motion). The inputs provide the raw data necessary for both identity and risk assessment.

The input data is processed through a Preprocessing Pipeline, which includes four key technical modules: adaptive image normalization 2210, which calibrates color balance and exposure; document boundary detection 2212, used to localize and extract ID card contours; multi-resolution pyramid processing 2214, which enables feature detection at various scales; and face detection and alignment 2216, which prepares facial imagery for downstream biometric analysis.

Following preprocessing, the refined data is passed into a Multi-Branch Neural Architecture, which consists of four parallel AI analysis streams. The document authentication branch 2218 applies an AI model such as a modified EfficientNet model with attention mechanisms and contrastive learning to identify tampering, watermark inconsistencies, and forged elements in government-issued ID documents. The facial recognition branch 2220 uses Vision Transformers (ViT) to extract age-invariant features and perform real-time liveness detection, micro-expression analysis, and facial similarity scoring. The text extraction branch 2222 utilizes the FLAN-T5 transformer and field-aware OCR to identify structured fields, perform layout-aware segmentation, and recognize characters using context-sensitive language models. In parallel, the environmental analysis branch 2224 evaluates ambient lighting, image quality, and device capabilities to generate a risk profile that influences final confidence thresholds.

The outputs from all branches are aggregated within the Feature Fusion Module 2226, which performs cross-modal attention and hierarchical feature alignment. The module integrates document, biometric, text, and environmental signals using an uncertainty-aware architecture to improve robustness under noisy or incomplete input conditions.

The fused output then feeds into decision logic systems. The multi-factor authentication unit 2228 conducts risk-calibrated verification using all available modalities, ensuring alignment between document data, face biometrics, and contextual indicators. The system also includes an anomaly detection engine 2230, based on one-class support vector machines (SVMs) and variational autoencoders (VAEs), which flags outlier behaviors or identities that deviate from expected user patterns. Finally, the architecture provides explainable results 2232 using methods such as Local Interpretable Model-Agnostic Explanations (LIME) and attention visualization, enabling administrators and users to audit and interpret the system's decision-making process.

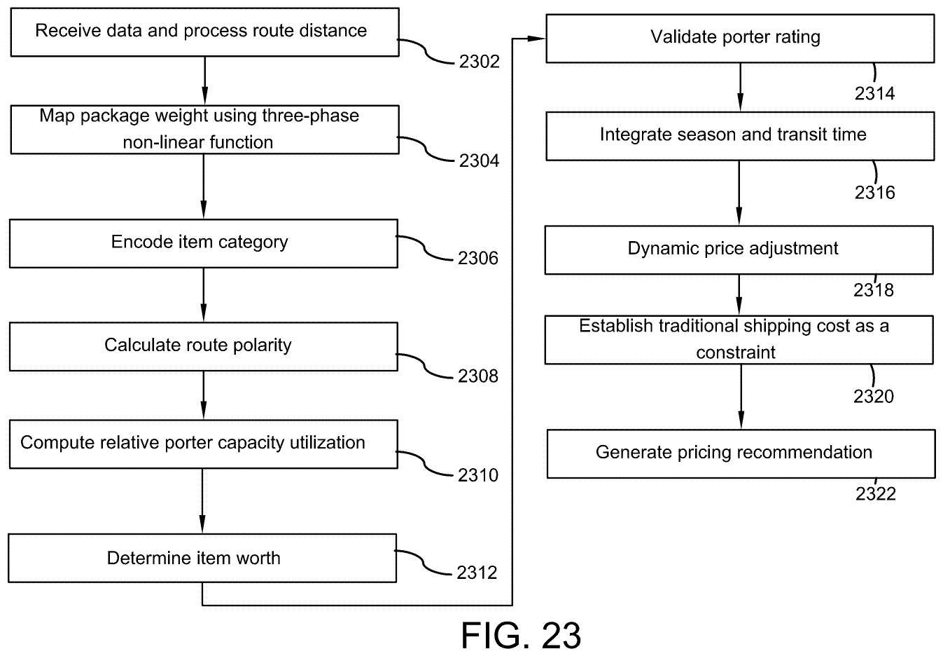

FIG. 23 illustrates a flowchart of a machine learning-based Pricing Recommendation in accordance with one embodiment of the present invention. The system 100 is configured to process a plurality of structured and semi-structured input features, derived from multiple sources including user-entered data, historical transaction records, system telemetry, and third-party APIs. The input features are categorized into primary, secondary, and constraint-based sets. Among the primary features, the system processes route distance, computed using the Haversine formula applied to the latitude and longitude coordinates of the origin and destination airports (Step 2302). The distance metric helps in correlating effort and cost incurred by the porter. The system also enforces a pricing guardrail, ensuring that the price recommendation does not exceed 50% of the lowest available rate offered by conventional shipping carriers for the same route.

The item weight is transformed using a novel three-phase non-linear weight pricing function, which maps weight values to corresponding price ranges across fifty discrete intervals (Step 2304). As a non-limiting example, the function comprises Phase 1 (1-10 lbs) for a steep price gradient reflecting limited low-weight capacity, Phase 2 (11-30 lbs) for a moderate price slope for medium-weight parcels, and Phase 3 (31-50 lbs) for a flattened curve reflecting diminishing marginal cost. The multi-phase mapping model is designed to optimize fairness and precision in cost recommendations and constitutes a novel and patentable feature of the pricing system. The item category feature is encoded using a one-hot vector representation (Step 2306), with predefined categories such as Documents, Books, and Clothes. A volumetric adjustment is implemented for Documents based on average page density to approximate physical weight equivalence. The flight date input is encoded cyclically using sine and cosine transformations to preserve periodic relationships such as seasonality. The encoded values are further refined using time-series decomposition techniques to isolate trend, seasonal, and residual components, thereby improving model responsiveness to historical patterns. The system evaluates route popularity (Step 2308) as a normalized frequency score using exponential smoothing over historical booking data to determine pricing elasticity. Simultaneously, the available porter capacity is monitored in real time by calculating the ratio of claimed space versus declared availability (Step 2310).

The system also performs item worth estimation (Step 2312), which is determined using an AI-driven image inference module. The estimation may employ a ResNet-50 convolutional neural network trained via transfer learning to estimate item value directly from uploaded parcel images. The system then applies bounded price modifiers based on the computed worth, within category-specific ranges.

In the secondary features, porter rating, which is integrated as a weighted average of previous delivery feedback, is adjusted with a recency bias and limited to a ±15% impact on the final recommended price (Step 2314). Porter competition level is modeled using an inverse exponential function of the number of active porters on the same route and date, while ensuring enforcement of a minimum viable price. Urgency premiums are applied using Time until flight departure, via a piecewise function applied at three critical thresholds: 7 days, 3 days, and 1 day, as examples (Step 2316). Additionally, a plurality of seasonality indicators as binary flags are used (Step 2318) and are tied to local and international holiday calendars. The system retrieves real-time traditional shipping costs from integrated third-party logistics APIs (e.g., FedEx™, UPS™) and establishes a price ceiling enforcement mechanism, ensuring that all recommended prices are automatically capped at 50% of the traditional courier benchmark (Step 2320) and generates a pricing recommendation (Step 2322).

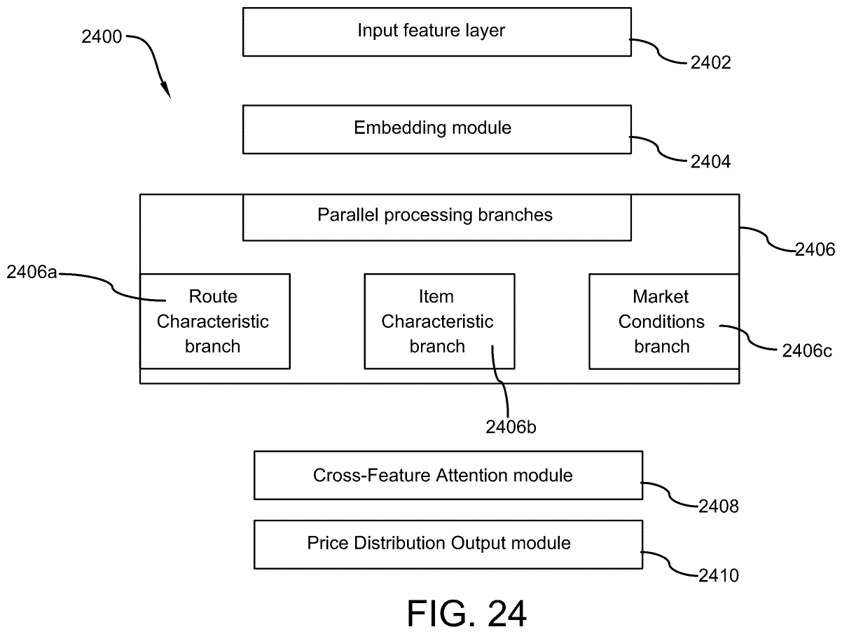

FIG. 24 illustrates a schematic neural network architecture diagram showing a hybrid deep learning model used for intelligent pricing prediction in the present invention, as per one embodiment. The architecture 2400 is designed to accommodate multi-modal inputs encompassing route information, item specifications, market dynamics, and temporal-spatial characteristics, producing a distributional price output optimized for elasticity and competitive alignment. An Input Feature Layer 2402 comprises structured data such as route distance, item category, item weight, porter rating, travel dates, available capacity, and environmental signals. The structured data is forwarded to an Embedding module 2404 for transformation into machine-readable formats. The embedding module 2404 processes: (i) numerical features using batch normalization and linear projection to a 32-dimensional latent space; (ii) categorical features using learned 16-dimensional entity embeddings; (iii) temporal features through harmonic embeddings to encode cyclical patterns such as seasonal demand; and (iv) spatial features via graph convolutional embeddings, enabling the model to infer logistical context from airport and regional adjacency data.

The transformed data is fed into a plurality of Parallel Processing Branches 2406, each branch is dedicated to specific subdomains of pricing logic. A Route Characteristics Branch 2406a utilizes a three-layer Graph Attention Network (GAT) with skip connections and layer normalization. The branch 2406a uses a hierarchical graph representation learning that incorporates airport-to-region clustering and dynamic geopolitical constraints. A second Item Characteristics Branch 2406b uses a multi-layer perceptron (MLP) combined with gated residual networks and adaptive normalization. The branch 2406b features category-specific attention modules and learned item value estimation using embedded outputs from image-based models. A third Market Conditions Branch 2406c employs a temporal convolutional network (TCN) with dilated causal convolutions and exponential dilation factors, enabling multi-scale pattern recognition of time-dependent features such as holiday fluctuations and route saturation trends.

The outputs from each branch are passed through a Cross-Feature Attention module 2408, which serves as a contextual fusion layer. The module 2408 employs multi-head attention (four heads with 64-dimensional outputs) with a contextual price-aware masking function that encodes price elasticity via a learned mask M applied to scaled dot-product attention, given as

$$Attention ( Q , K , V ) = softmax ( QK \hat{} T / √ d + M ) V$$

A Price Distribution Output module 2410 produces quantile-based predictions using a quantile regression ensemble. Specifically, the module 2410 forecasts the 10th, 25th, 50th, 75th, and 90th percentiles of the delivery price range, facilitating uncertainty-aware decision-making. The output layer incorporates a custom activation function that reflects the three-phase weight-price curve used by the platform, including Phase 1 (1-10 lbs), high slope to penalize low-weight inefficiencies; Phase 2 (11-30 lbs), moderate pricing slope; Phase 3 (31-50 lbs), approaches a price ceiling. The platform 100 is bounded between a minimum cost (such as $40) and a maximum cost (such as $350), and constrained dynamically through a competitive normalization layer that aligns predictions with real-time shipping benchmarks.

A Loss Function is implemented for pricing and is a composite function optimized for both statistical accuracy and business rule adherence.

$$L\_total = α \cdot L\_quantile + β \cdot L\_competitive + γ \cdot L\_market + δ \cdot L\_elasticity$$

L_quantile: Pinball loss for quantile regression, L_competitive: Binary cross-entropy loss for competitive pricing constraint, L_market: Kullback-Leibler divergence between predicted and observed price distributions, L_elasticity: Custom loss term penalizing price sensitivity violations.

It should be noted that the system 100 uses a Dual-Sided Marketplace Data Framework, which is configured to simultaneously collect, structure, and analyze data streams from both key actors; senders and porters. The framework enables bidirectional interaction capture, including behavioral signals such as preference indications, price offer acceptance thresholds, and real-time negotiation flows. The system 100 utilizes a custom data collection protocol that structures marketplace interactions into analyzable formats, enabling fine-grained pattern recognition while enforcing strict user privacy rules.

The system 100 also uses Temporal-Spatial Price Elasticity storage, which is a uniquely structured data repository optimized for route-based price sensitivity analysis over time. The storage or database schema captures fluctuations in price elasticity at the intersection of geography and chronology, accounting for both short-term influences (e.g., holiday demand spikes or regional events) and long-term pricing trends. The system also implements a multi-dimensional indexing mechanism that enables rapid query and retrieval of price elasticity data for any given route and time window, facilitating real-time dynamic pricing decisions.

As discussed above, the sender can designate a delivery of the package (i.e., ‘ship to’) to the traveler from a third-party (i.e., Amazon™). This can be initiated when the traveler has identified luggage capacity and the sender then reserves the luggage capacity. In this manner the traveler is ‘porting’ the package that arrives to the traveler through a third-party. This feature enables senders to reserve a traveler's available baggage capacity in advance, order goods from a third-party and designate directly ‘ship to’ the traveler's U.S. address. Specifically, the sender can reserve a traveler's baggage space (i.e., capacity) and then have a third-party ship a package directly to the traveler. The tasks of interfacing the sender, the third-party, and the traveler comprise the following tasks: initiate an order from a third-party, identify traveler with baggage capacity, reserve traveler baggage capacity, generate traveler's U.S. delivery address and identification including package tracking number, and designate ‘ship to’ address as the traveler's address. The traveler can then receive the package from the third-party, verify the correct package item, and carry it domestically and/or internationally to the receiver. The described ‘porter app’ automates end-to-end package reservation, ordering, and tracking flow for both senders and travelers. The activities of the third-party are integrated (i.e., communicated) into the ‘porter app’ to inform the sender and the traveler of the package status. In this manner, the ‘porter app’ integrates third-party tracking updates into sender ‘dashboard’ and traveler delivery address, implements reminder notifications for traveler when the package is inbound, builds insurance validation and payout system, provides weight reconciliation and audit system, implements penalty/reward system for missed or successful deliveries.

In another embodiment, the ‘porter app’ enables registered receivers overseas, for example, to proactively search travelers heading toward their country, reserve luggage space, and place local third-party orders in the traveler's departure country. This method provides flexibility for receivers to control procurement without depending on senders, creating a “reverse logistics” experience. The receiver initiated transaction comprises finding a traveler departing from a specific country, reserving part of their baggage space, and coordinating local purchases for delivery to the traveler. In this manner, the receiver orders, for example, items from the departure country's third-party site and sends the items to the traveler to carry back to the receiver's country. The traveler receives and verifies packages addressed to the traveler, carries them during the trip, and delivers them to the designated receiver abroad or domestically. The aforementioned steps comprise the following steps: notifying the traveler of reserved incoming package, implementing package receipt confirmation system, enabling in-transit status updates, confirming final delivery to receiver upon arrival, and linking successful delivery to reward release. Certain terms are used throughout the following description and claims to refer to particular features or components. As one skilled in the art will appreciate, different persons may refer to the same feature or component by different names. This document does not intend to distinguish between components or features that differ in name but not structure or function. As used herein “crowd-sourced package delivery system”, “peer-to-peer logistics platform”, “peer-to-peer package delivery”, and “system” are interchangeable and refer to the peer-to-peer package delivery system 100 of the present invention.

Notwithstanding the forgoing, the peer-to-peer package delivery system 100 of the present invention can be of any suitable configuration as is known in the art without affecting the overall concept of the invention, provided that it accomplishes the above stated objectives. One of ordinary skill in the art will appreciate that the peer-to-peer package delivery system 100 as shown in the FIGS. are for illustrative purposes only, and that many other configuration and design of the peer-to-peer package delivery system 100 are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A crowd sourced package delivery system comprising:
a crowd sourced peer-to-peer package delivery system connecting a sender and a traveler having a mobile application, a server, a network, and an electronic computing device;
a user management module;
a package information module;
a matching module;
a communication module; and
a payment module;
wherein said sender having a package for sending;
wherein said traveler having carrying capacity for accepting said package;
wherein said user management module having functions selected from the group consisting of a user registration, a user authentication, a profile management of users, a user role assignment, and a user verification;
wherein said user role assignment is one of said sender and said traveler;
wherein said user verification including a document selected from the group consisting of an identification document and a travel document;
wherein said package information module having information selected from the group consisting of said traveler's travel data, a carrying capacity availability, and a sender package data;
wherein said matching module connecting said sender and said traveler based upon one or more of said traveler's travel data, said carrying capacity availability, and said sender package data;
wherein said sender package data includes information selected from the group consisting of a package location, a desired delivery window, a package weight, a package dimension, and a package type;
wherein said communication module having an in-app messaging interface for sharing said sender package data with said traveler; and
further wherein said payment module transacting payments between said sender and said traveler.

2. The crowd sourced package delivery system of claim 1, wherein said carrying capacity is unused carrying capacity in said traveler's luggage.

3. The crowd sourced package delivery system of claim 1, wherein said payment module integrates a third-party gateway escrow.

4. The crowd sourced package delivery system of claim 1, further comprising a package tracking module monitoring a status of said traveler, wherein said package tracking module updates said sender of said status of said traveler.

5. The crowd sourced package delivery system of claim 4, wherein said status of said traveler includes information selected from the group consisting of a real-time flight tracking, a real-time data on flight number, a current flight status, and an Estimated Time of Arrival.

6. The crowd sourced package delivery system of claim 1 further comprising a reporting module providing metrics selected from the group consisting of a request accepted confirmation, a transaction tracking, a record of financial activity, an historical log of said packages sent, a delivery status, and a timestamp of said package.

7. The crowd sourced package delivery system of claim 1, wherein said traveler's travel data includes information selected from the group consisting of a drop-off address, a departure location, a destination location, a departure time, and a destination time.

8. A method of crowd sourcing a package delivery, the method comprising the steps of:
providing a crowd sourced peer-to-peer package delivery system connecting a sender and a traveler having a mobile application, a server, a network, and an electronic computing device;
providing a user management module, a package information module, a matching module, a communication module and a payment module, wherein said sender having a package for sending, wherein said traveler having carrying capacity for accepting said package;
providing said user management module with functions selected from the group consisting of a user registration, a user authentication, a profile management of users, a user role assignment, and a user verification, wherein said user role assignment is one of said sender and said traveler, wherein said user verification including a document selected from the group consisting of an identification document and a travel document, wherein said package information module having information associated with said traveler's travel data, carrying capacity availability, and sender package data;
connecting with said matching module said sender and said traveler based upon one or more of said traveler's travel data, said carrying capacity availability, and said sender package data, wherein said sender package data includes information selected from the group consisting of a package location, a desired delivery window, a package weight, a package dimension, and a package type;
sharing said sender package data with said traveler through said communication module including an in-app messaging interface; and
transacting payments with said payment module between said sender and said traveler.

9. The method of crowd sourcing a package delivery of claim 8, wherein said carrying capacity is unused carrying capacity in said traveler's luggage.

10. The method of crowd sourcing a package delivery of claim 8, wherein said payment module integrates a third-party gateway escrow.

11. The method of crowd sourcing a package delivery of claim 8 further comprising a package tracking module monitoring a status of said traveler, wherein said package tracking module updates said sender of said status of said traveler.

12. The method of crowd sourcing a package delivery of claim 11, wherein said status of said traveler includes information selected from the group consisting of a real-time flight tracking, a real-time data on flight number, a current flight status, and an Estimated Time of Arrival.

13. The method of crowd sourcing a package delivery of claim 8, wherein said traveler's travel data includes information selected from the group consisting of a drop-off address, a departure location, a destination location, a departure time, and a destination time.

14. The method of crowd sourcing a package delivery of claim 13 further comprising the step of delivering said package to said drop-off address, wherein said drop-off address is a ‘ship to’ address for another third-party to deliver said package to said drop-off address.

15. A method of crowd sourcing a package delivery, the method comprising the steps of:
providing a crowd sourced peer-to-peer package delivery system connecting a sender and a traveler having a mobile application, a server, a network, and an electronic computing device;
providing a user management module, a package information module, a matching module, a communication module, a payment module, and a reporting module, wherein said sender having a package for sending, wherein said traveler having carrying capacity for accepting said package;
providing said user management module with functions selected from the group consisting of a user registration, a user authentication, a profile management of users, a user role assignment, and a user verification, wherein said user role assignment is one of said sender and said traveler, wherein said user verification including a document selected from the group consisting of an identification document and a travel document, wherein said package information module having information associated with said traveler's travel data, carrying capacity availability, and sender package data;
connecting with said matching module said sender and said traveler based upon one or more of said traveler's travel data, said carrying capacity availability, and said sender package data, wherein said sender package data includes information selected from the group consisting of a package location, a desired delivery window, a package weight, a package dimension, and a package type;
sharing said sender package data with said traveler through said communication module including an in-app messaging interface;
transacting payments with said payment module between said sender and said traveler; and
reporting metrics through said reporting module, wherein said reporting metrics selected from the group consisting of a request accepted confirmation, a transaction tracking, a record of financial activity, an historical log of said packages sent, a delivery status, and a timestamp of said package.

16. The method of crowd sourcing a package delivery of claim 15, wherein said carrying capacity is unused carrying capacity in said traveler's luggage.

17. The method of crowd sourcing a package delivery of claim 15 further comprising a package tracking module monitoring a status of said traveler, wherein said package tracking module updates said sender of said status of said traveler.

18. The method of crowd sourcing a package delivery of claim 15, wherein said status of said traveler includes information selected from the group consisting of a real-time flight tracking, a real-time data on flight number, a current flight status, and an Estimated Time of Arrival.

19. The method of crowd sourcing a package delivery of claim 15, wherein said traveler's travel data includes information selected from the group consisting of a drop-off address, a departure location, a destination location, a departure time, and a destination time.

20. The method of crowd sourcing a package delivery of claim 19 further comprising the step of delivering said package to said drop-off address, wherein said drop-off address is a ‘ship to’ address for another third-party to deliver said package to said drop-off address.
